(19) United States
(12) Patent Application Publication
(10) Pub. No.: US 2007/0100499 A1
(43) Pub. Date: May 3, 2007

(54) Method and apparatus for heads-up critical information display on air traffic control tower glass window walls

(75) Inventor: Kathy Lynn Staub, Daytona Beach, FL (US)

Correspondence Address: Martin E. Robinson, Jr.;Federal Aviation Administration, AGC-500, 800 Independence Ave. SW, Washington, DC, 20591, US

(73) Assignee: Government of the United States Federal Aviation Administration, Washington, DC (US)

(21) Appl. No.: 11/476,677

(22) Filed: Jun. 29, 2006

Related U.S. Application Data
(60) Provisional application No. 60/695,442, filed on Jul. 1, 2005.

(51) Int. Cl. G06F 19/00

(52) U.S. Cl. 700/245

(57) ABSTRACT

A heads-up display system that can be configured to display critical information on the glass window wall in an air traffic control tower cab so an air traffic controller can view the information without taking his or her eyes off the runways or movement areas. Multiple input devices communicate critical information to a computer's central processing unit which processes the information, creates a display, and sends it to a display device. The display device creates a substantially transparent image of the critical information on the window wall of an air traffic control tower.

### CROSS REFERENCE TO RELATED APPLICATIONS

This application claims the priority benefit of U.S. Provisional Application No. 60/695,442, filed on Jul. 1, 2005, which is incorporated herein by reference.

### STATEMENT OF GOVERNMENT INTEREST

The present invention may be made or used by or for the Government of the United States without the payment of any royalties thereon.

### FIELD OF THE INVENTION

The present invention is related to air traffic control, particularly to a heads-up display system to display critical runway status and other information outside of, in front of, or directly on an air traffic control tower window wall.

### BACKGROUND OF THE INVENTION

One of the most critical safety problem areas in air traffic control is runway incursions. A runway incursion occurs when an aircraft, vehicle, or pedestrian transgresses on an active runway while it is being used by another aircraft to land or take off.

Runways are in use not only for landing, rolling out aircraft, and aircraft departures, but also for crossing aircraft, crossing vehicles, runway inspections, and runway maintenance. Generally, three people, the local controller, the ground controller, and the cab coordinator, working as a team must flawlessly keep up with this changing status to perform their jobs without a runway incursion. Runway status information will pass between these three people verbally, via a heads-down status display, or other visual aid.

For controllers in the air traffic control towers across the United States, runway incursions are the top problem area. The Federal Aviation Administration has been looking for solutions to this problem for years, but nothing new has been discovered or developed to help the air traffic controllers with this problem. The reason is that an air traffic controller has a multitude of information inputs he or she must use to make decisions each second while working air traffic. The sheer amount of information an air traffic controller must process and the fact it changes constantly means that the controller only partially remembers some information, incorrectly remembers other information, or completely forgets some information.

When an air traffic controller makes a runway incursion error, the investigation usually finds that the information required to make a successful decision was available. The controller was given the information, but the controller made a mistake. The controller's “intake” of the information was not successful. The controller did not absorb the most recent information. The controller's brain cannot keep up with that much information. The controllers need aids for their memory.

The currently used memory aids are not good enough. The memory aids currently used by air traffic controllers to remember runway status are notes hand written on paper, computer monitor screens, console displays of airport status items, or no memory aids at all which means the controller is relying on his or her memory alone. The problem with the currently used memory aids is that they are heads-down. They require a controller to stop looking at the runway, sky, or movement area to concentrate on interpreting written data. An air traffic controller cannot afford to take his or her focus off of airplanes to use these aids. They break the continuity of his or her traffic picture.

The purpose of the present invention is to reduce runway incursions by providing the air traffic controller team with a source of information about the runways that is heads-up and continually in the field of vision, but at the same time passively available.

An additional purpose of the invention is to put the Automated Terminal Radar System (ARTS), Standard Terminal automation Replacement System (STARS) Tower Display Workstation (TDW) or other displays onto the window walls of the air traffic control tower. This invention will make the Tower's radar display a heads-up transparent tool. For example, the STARS TDW display is a 20″ by 20″ flat panel radar scope that is used in air traffic control Towers. A Tower at a small airport will use the TDW to view the location and actions of inbound and outbound aircraft out of visual range, normally up to 15 miles around the airport. The TDW is either mounted on the console, where the problem is that it is a heads-down immovable display, or it is mounted on an arm attached to the ceiling. Ceiling mounting is an effort to make it easy for the air traffic controller to transition to looking out the window. In the case where it is attached to the ceiling, each controller moves the TDW to a location that allows him or her to best see both live traffic and the radar display. Regardless of how it is positioned, the TDW radar display blocks a 20″ by 20″ square of their view out the window.

Heads-up display systems have been developed and successfully used in aircraft to allow a pilot to passively view flight or target information while simultaneously viewing the ground or target in the same viewing area. The problems with these systems are that they may require a curved reflective surface to view the displayed information or require a special reflective coating on the viewing surface to display the information. These systems usually require the pilot's eye to be in a specific location and angle to view the display. These display systems have a very small viewing angle.

### SUMMARY OF THE INVENTION

The present invention displays critical information, such as “RUNWAY UNAVAILABLE” outside of, in front of, or directly on the window walls of the air traffic control tower cab. The information is displayed at optical infinity. This means that the air traffic controller does not have to refocus his or her eyes (which takes several tenths of a second) to view the information while at the same time keeping track of the situation outside of the air traffic control tower. The air traffic controller will always be able to see the situation outside the tower while simultaneously viewing the displayed information. An air traffic controller is thus able to monitor critical data while his or her attention is focused outside the control tower on aircraft activities. The core benefit of the present invention is it minimizes the head-up to head-down to head-up transition. The present invention allows the air traffic controller to passively absorb critical runway status and other information because the information is already in their field of view. They don't have to look down to get the information, and they don't have to take their focus off of their traffic picture to get the information. The present invention improves the controller's reaction time because it saves time in information access. This increases safety. The earlier a controller detects a conflict and acts to avert it, the larger the margin of safety.

The present invention is a heads-up critical information display system that communicates critical information from one or more input devices to a computer's central processing unit. The computer's central processing unit has software that accepts the critical information from the input devices and processes it to create a display, and then sends this information to a display device. The display device creates a transparent image of the critical information outside of, in front of, or directly on the window wall of an air traffic control tower.

### BRIEF DESCREPTION OF THE DRAWINGS

FIG. 1 is a block diagram of the equipment.

FIG. 2 is an illustration of the runway “capture boxes.”

### DETAILED DESCRIPTION OF THE INVENTION

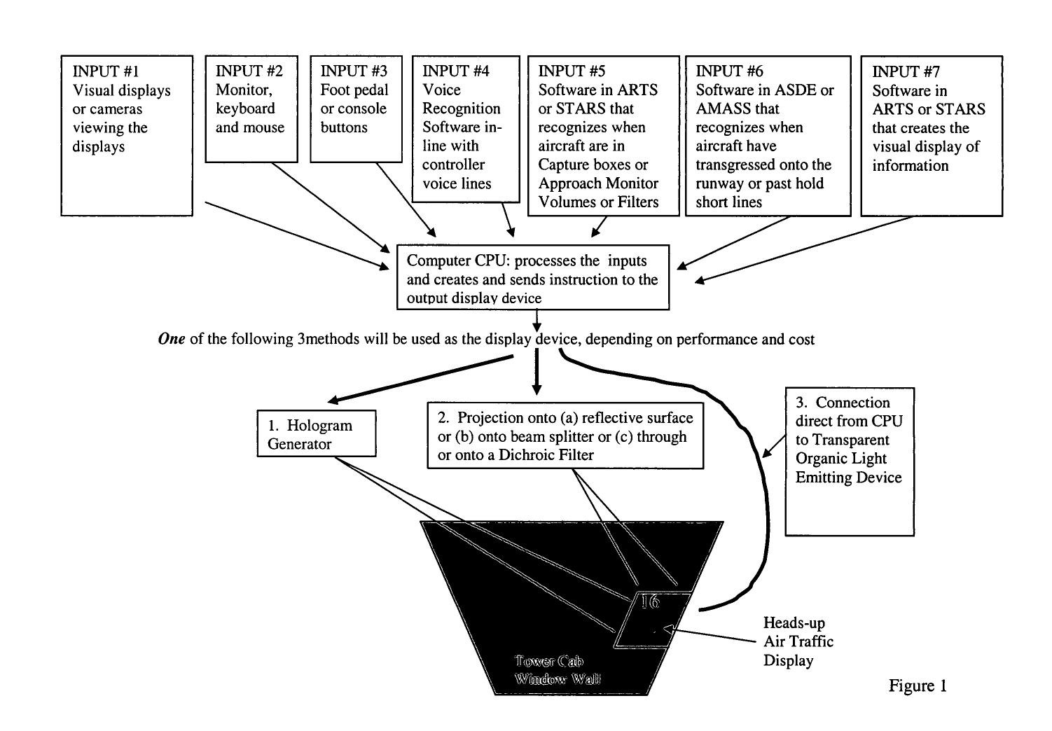

Referring to FIG. 1, there is one or more input devices that communicate critical information to the computer's central processing unit (CPU). These input devices can be a keyboard, mouse, and monitor combination, a momentary contact electrical switch, a voice recognition system, capture box input, inputs from other existing equipment such as the Airport Surface Detection Equipment (ASDE) or Airport Movement Area Safety System (AMASS), or inputs from Radar or other displays.

One type of input device is a computer keyboard, mouse, and monitor combination. This combination will allow an air traffic controller to input information into the computer's central processing unit. It will also allow the controller to create, view, and adjust the image before it is sent to the window wall display.

A second type of input device is a momentary contact electrical switch. This switch could be in the form of a foot pedal at the air traffic controller's position or a push button switch installed on the controller's console. Depressing the foot pedal or push button would tell the computer's central processing unit to toggle the runway status between “RUNWAY UNAVAILABLE” and “RUNWAY AVAILABLE.”

A third type of input device would be a voice recognition system. In this instance a voice recognition computer and software would be hardwired in-line with the air traffic controller's transmitter lines. All voice transmissions in an air traffic control tower are sent via hardwired telephone lines to the ground-to-air transmitters. The voice recognition system would be used to recognize a few key phrase such as “Cross runway seven left” and “Clear of runway seven left.”

The voice recognition software would be listening on the line. When the software recognizes the first phrase, “Cross Runway Seven Left,” it would cause the voice recognition computer to send a signal to the invention's computer central processing unit causing it to activate the “RUNWAY UNAVAILABLE” display. Conversely, the second phrase, “Clear of Runway Seven Left,” would cause the voice recognition computer to send a signal to the invention's computer central processing unit causing it to activate the “RUNWAY AVAILABLE” display.

Other important phrases could also be used to activate the display such as “Position and hold runway 3 left” and “Cleared for takeoff runway 34.” The window display could be set to start to flash when, for example, the “N17XX position and hold” clearance is 20 seconds old, and the voice recognition software has not heard “N17XX cleared for takeoff.”

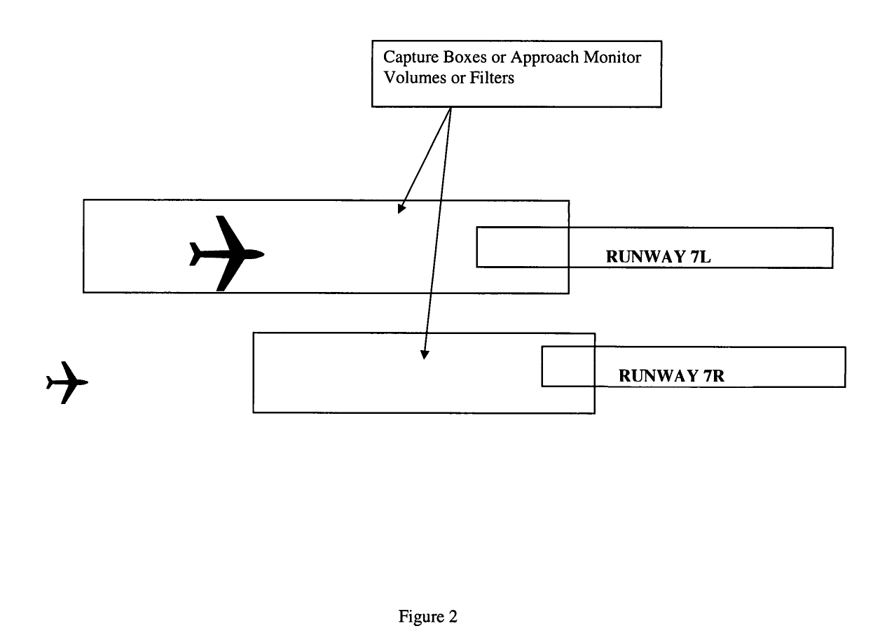

A fourth type of input device is to have software written to take the data output the Automated Radar Terminal System (ARTS) or the Standard Terminal Automation Replacement System (STARS) “capture boxes,” and route it to the invention's computer's central processing unit. Currently, in the Automated Radar Terminal System and the Standard Terminal Automation Replacement System software which runs a radar display scope, there are “capture boxes.” For example, when an aircraft is at 700 feet altitude in the middle of nowhere, this software activates an audio low altitude alarm for the air traffic controller. However, when an aircraft is 700 feet altitude but in a “capture box” drawn along the approach to a runway (See FIG. 2), no alarm is triggered because 700 feet is acceptable to the software in that specific location. (Technically, these different areas are called Approach Monitor Volumes, or Arrival Filters, or Surface Tracking Filters, or Capture Boxes, among other terms.)

“Capture boxes” would be “drawn” in the software at the approach end of each runway. An aircraft at a low altitude and a certain distance from the runway threshold would be seen by Automated Radar Terminal System or Standard Terminal Automation Replacement System software as landing, and this would send a message to the invention's computer's central processing unit to activate the “RUNWAY UNAVAILABLE” display. This capability would also be used to alert the air traffic controller that an aircraft entered the “capture box” for a closed runway. In this case, an audible alarm would be triggered.

A fifth type of input device would be to accept runway status inputs from other existing equipment. The invention could be configured to work with other existing air traffic control equipment such as the Airport Surface Detection Equipment or Airport Movement Area Safety System, thus enhancing the usefulness of each system.

A sixth type of input device is feeds from the Automated Terminal Radar System, Standard Terminal Automation Replacement System, other displays, or cameras viewing these displays.

Three methods are available to implement the display device. The three methods are to use a hologram generator, a two dimensional projection, or a transparent organic light emitting device.

The first method to implement the display device is to use a holographic apparatus to create a hologram. The image would be “on the glass” in the sense it would appear to be in front of the tower cab window glass in mid air.

The second method is to use a two-dimensional projection display device. The computer's central processing unit would generate the image itself. In one configuration, the reflective qualities of the tower cab window glass, transparent window shade, or transparent panel would cause the projected image to appear. Another configuration would be to use a beam splitter to make the image appear in the same way that a teleprompter uses a beam splitter to cause text to appear at only certain viewing angles. A third configuration is to use a dichroic filter. The dichroic characteristics of the filter will allow all colors except one to pass through. A one color image would be projected onto and reflected by the filter, thereby appearing on the tower cab window glass.

The third method is to use a Transparent Organic Light Emitting Device (TOLED). The TOLED is proprietary technology developed by the Universal Display Corporation. A TOLED is created by using a transparent contact structure to create a transparent display. The structure would be applied to a panel fixed in front of the glass. When activated, it will display an image on the tower cab window glass.

The display itself can be on the tower cab windows themselves or on a shade or panel. The shade would be a drawn-down, full window size with transparent or reflective properties. The panel would be a transparent panel that is fixed just in front of the tower cab window or affixed to the tower cab window itself.

I claim:

1. A heads-up critical information display system comprising:
an input device that communicates critical information to a computer's central processing unit;
a computer central processing unit and software that accepts critical information from said input device, processes it, creates a display, then sends the information to a display device;
a display device that creates an image of the critical information; and
a substantially transparent display on which the said display device creates an image of the critical information on the window wall of an air traffic control tower;
software in the Airport Surface Detection Equipment or Airport Movement Area Safety System that recognizes when aircraft have transgressed onto a runway or past hold short lines; and,
software in the Automated Radar Terminal System and the Standard Terminal Automation Replacement System that creates the visual display of radar information.

2. The heads-up critical information display system of claim 1 wherein the display device comprises a hologram generator.

3. The heads-up critical information display system of claim 1 wherein the display device comprises a projector that projects an image onto a reflective surface, onto a beam splitter, or through or onto a dichroic filter.

4. The heads-up critical information display system of claim 1 wherein the display device comprises a transparent organic light emitting device.

5. The heads-up critical information display system of claim 1 wherein the display on the window wall of an air traffic tower comprises the air traffic control tower window wall itself.

6. The heads-up critical information display system of claim 1 wherein the display on the window wall of an air traffic control tower comprises a substantially transparent shade.

7. The heads-up critical information display system of claim 1 wherein the display on the window wall of an air traffic control tower comprises a reflective shade.

8. The heads-up critical information display system of claim 1 wherein the display comprises a substantially transparent panel.

9. The heads-up critical information display system of claim 1 wherein the display comprises a reflective panel.

10. A method of using a heads-up display system to display critical information comprising:
inputting critical information from an input device into a computer's central processing unit;
processing the critical information using software contained in the computer's central processing unit to create a display;
sending the display information to a display device; and
using the display device to create a substantially transparent image on the window wall of an air traffic control tower.
